(19) United States
(12) Patent Application Publication
(10) Pub. No.: US 2003/0223051 A1
(43) Pub. Date: Dec. 4, 2003

(54) Floor support with passive shear wave cancellation

(76) Inventor: Mats A. Engwall, San Juan Bautista, CA (US)

Correspondence Address: McGuireWoods LLP, Suite 1800, Tysons Corner, 1750 Tysons Boulevard, McLean, VA, 22102-4215, US

(21) Appl. No.: 10/160,186

(22) Filed: Jun. 4, 2002

(51) Int. Cl. G03B 27/58

(52) U.S. Cl. 355/72; 355/75; 355/53; 378/34; 310/10

(57) ABSTRACT

In a mechanical system for precision movement (such as a photolithography apparatus for patterning a reticle stage or wafer stage in semiconductor production), undesirable external forces (e.g., ground movement) are minimized and controlled. A floor support customized for the particular mechanical system is provided.

### DESCRIPTION

### BACKGROUND OF THE INVENTION

1. Field of the Invention

This invention relates generally to mechanical systems that may be affected by undesirable movement, and more specifically to a precision motion stage.

2. Background Description

Certain precision mechanical systems have been provided, such as a photolithography apparatus including a guided stage mechanism suitable for supporting a reticle or wafer used in making semiconductor devices. As seen in FIG. 5 of U.S. Pat. No. 5,874,820, for example, a photolithography apparatus may be supported by a supporting base structure 100 that supports the photolithography apparatus including a frame 94. The base structure (e.g., base structure 100) may support vertical pillars (such as pillars 102A, 102B, 102C, 102D) and may be of relatively large size, such as approximately 3 meters top to bottom. The base structure may be in contact with the ground via a conventional foundation (not shown in FIG. 5). Such precision mechanical systems may be relatively heavy, for example, on the order of tons, and generally such relatively large mechanical systems are somehow disposed on the ground, directly or indirectly.

In precision mechanical systems (such as systems containing lithographical stages for precision patterning of semiconductor wafers), external movements (such as vibrations) pose significant problems for precision and accuracy. Efforts to control vibrations and deformations in a positioning device have been made. For example, U.S. Pat. No. 5,744,924 teaches isolation blocks 20 composed of a vibration absorbing assembly to prevent transmission of the vibration from the foundation (ground) 21, while WO 96/38767 discloses a positioning device with an object table and a drive unit. The object table is displaceable over a guide parallel to at least an x-direction, which guide is fastened to a first frame of the positioning device. A stationary part of the drive unit is fastened to a second frame of the positioning device that is dynamically isolated from the first frame. A reaction force exerted by the object table on the drive unit during operation and arising from a driving force exerted by the drive unit on the object table is transmittable exclusively into the second frame.

While the disadvantageous effects of external forces on the mechanical system, directly or via the ground, sometimes have been recognized, those undesirable external forces have yet to be completely controlled. The conventional systems and methods are believed not to fully eliminate or control such external forces (such as ground movements), and further systems and methods for reducing and minimizing those undesirable external forces would be a useful development.

### SUMMARY OF THE INVENTION

The present invention is based on the recognition that, when a mechanical system for precision movement is disposed on the ground, the mechanical system may be subject to undesirable external forces, such as undesirable external forces applied directly to the mechanical system itself (such as a force inadvertently contacting the mechanical system) and/or movement of the ground. That is, vibrations in one part of the mechanical system are disadvantageously transmitted to other parts of the mechanical system through the ground (base or foundation member), even if the two parts are not directly in contact.

The present invention minimizes and/or controls such undesirable forces, whether they be internal or external to the mechanical system, by identifying wavefront cancellation points in the ground at which the disturbance has a minimum amplitude, and locating supports for at least part of the mechanical system at those points. To provide such advantageous features, the invention in a first embodiment provides a method of minimizing an undesirable disturbance experienced in a mechanical system sensitive to vertical displacements, comprising the steps of:

(i) dividing the undesirable disturbance into at least a first divided wavefront and a second divided wavefront, the at least first and second divided wavefronts entering a ground surface at different points and interfering with each other therein to form a composite wavefront;

(ii) locating a cancellation point within the ground surface whereat the at least first and second divided wavefronts destructively interfere with each other and minimize an amplitude of the composite wavefront; and

(iii) positioning a support of the mechanical system at the cancellation point.

The invention, in another embodiment, provides a support system for supporting a mechanical system, comprising: at least three support devices, the support devices comprising:

(i) a first member having an upper end and a lower end, the lower end being secured to a ground surface at a ball joint; and

(ii) a second member having a distal end and a proximal end, the proximal end being secured to the first member at a first revolute joint, the distal end being secured to the ground surface at a second revolute joint remote from the ball joint.

Another embodiment of the invention provides an exposure apparatus, comprising:

(i) a precision movement system sensitive to vertical displacements mounted on a ground surface;

(ii) a mechanical system mounted to at least three support devices, each of the support devices comprising: a first member having an upper end and a lower end, the lower end being secured to the ground surface by a first joint incapable of sustaining a moment; and a second member having a distal end and a proximal end, the proximal end being secured to the first member at a junction point, the distal end of the second member being secured to the ground surface at a second joint remote from the first joint, wherein the mechanical system is mounted to the at least three support devices at respective upper ends of the at least three support devices.

Some details of the inventive methods, apparatus and systems may include as follows, without the invention being limited to such details. In the invention, there may be performed a step of providing an initial pathway for the undesirable disturbance along a first member, and the step of dividing the undesirable disturbance further may further include dividing the undesirable disturbance at a joint connecting the first member and the second member.

With regard to a joint mentioned for use in the inventive methods, apparatuses, and systems, particular examples of the joint may be one of a ball joint, a fork joint and a pin joint. With regard to the members mentioned, an example may include the first member comprising a substantially vertical rod and the second member comprising a tension-compression rod; another example is the first member being attached to the ground surface at a ball joint and the second member being attached to the ground surface at one of a ball joint, fork joint and a pin joint.

In a further embodiment, the first divided wavefront travels along the second member into the ground surface and the second divided wavefront travels along the first member into the ground surface. In another embodiment, the step of dividing the undesirable disturbance comprises dividing the undesirable disturbance into two divided wavefronts.

In still another embodiment, the invention provides a support system that comprises three floor supports. As to the mentioned first member, it is preferred that the first member be substantially vertical. Also, it is a detail of the present invention that the upper end of the first member be adapted for attachment to the mechanical system (which may be several tons in mass and/or a mechanical system for precision movement and/or a photolithographic apparatus). It is also an embodiment that the support system provide interference between at least two divided wavefronts of an disturbance experienced by the mechanical system.

Further optional details may further include a second mechanical system sensitive to vertical displacements, the second mechanical system having supports located at points whereat the interference between the at least two divided wavefronts is destructive. The mentioned junction point may be, for example, a revolute joint capable of sustaining a moment in one direction. In the invention, a disturbance experienced by the mechanical system may be divided into a first divided wavefront and a second divided wavefront at each support device, the first and second divided wavefronts being transferred into the ground surface through the support devices. The first and second divided wavefronts may interfere with each other in the ground surface to form at least one composite wavefront; and/or the precision movement system may be mounted to the ground surface at points whereat an amplitude of the at least one composite wavefront is a minimum. A device manufactured with the exposure apparatus and a wafer on which an image has been formed by the exposure apparatus may also be provided.

### BRIEF DESCRIPTION OF THE DRAWINGS

FIG. 1 is a side view of an exemplary apparatus according to the present invention;

FIG. 2 is a free-body diagram of FIG. 1;

FIGS. 3A-3C are side views of the propagation of shear and compression waves in the present invention;

FIG. 4A is a floor plan including three support devices according to the present invention;

FIG. 4B is a top view of the floor plan of FIG. 4A with the three support devices installed and ready to receive a mechanical system;

FIG. 5 is a floor plan including four support devices according to the present invention;

FIG. 6 is a schematic view illustrating a photolithography apparatus according to the invention;

FIG. 7 is a flow chart showing semiconductor device fabrication; and

FIG. 8 is a flow chart showing wafer processing.

### DETAILED DESCRIPTION OF A PREFERRED EMBODIMENT OF THE INVENTION

As the mechanical system in, under, or for which the present invention may be used may be mentioned any mechanical system that is responsible for providing precision movement and that may be subject to applied horizontal forces (e.g., dynamically applied horizontal forces, such as bumping of the mechanical system, ground movement transferring to the mechanical system, etc.). Where “ground” or “ground movement” is mentioned herein, reference is made to the earth, any building floor surface, any aircraft floor surface, any watercraft floor surface, any vehicle floor surface, base, foundation member, etc. As a preferred example of a mechanical system suitable for use of the present invention may be mentioned a photolithography system for patterning reticles, wafers, etc. used in semiconductor production, and as a most preferred example, a several-ton photolithography system.

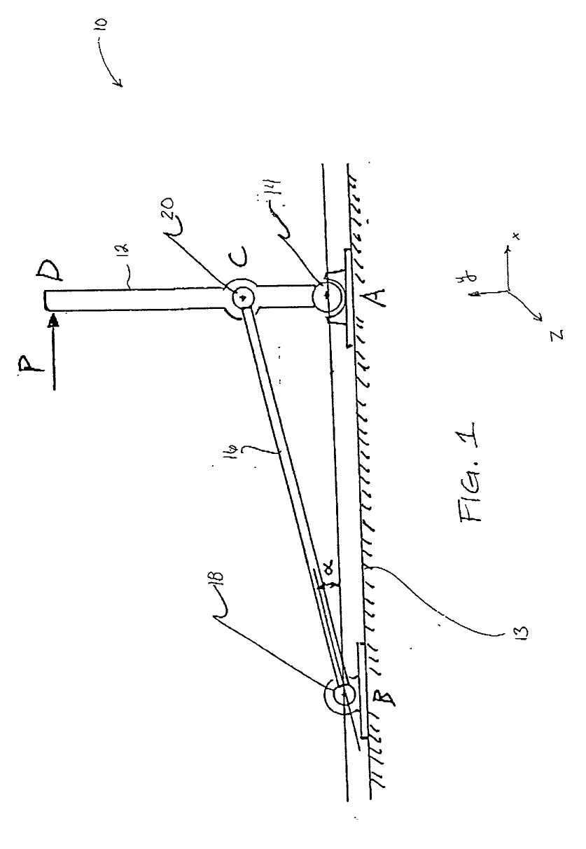

Referring now to the drawings, and more particularly to FIG. 1, a floor support device 10 of an exemplary form in accordance with an embodiment of the invention is shown. The floor support device 10 minimizes applied horizontal forces P, such as the dynamically applied horizontal forces noted above. The force P is introduced at an upper end D of an essentially vertical post 12, which is supported at the ground 13 by a joint 14, such as a ball joint, at a lower end A. It should be understood, however, that post 12 need not be essentially vertical; in such cases, one skilled in the art will be able to make the appropriate adjustments to the equations presented below and practice the present invention accordingly. Likewise, one skilled in the art will recognize the modifications to the analysis if the force P has components in directions other than the x-direction. Furthermore, it should be understood that joint 14 may be any type of joint that transfers only forces to the ground 13 (that is, joint 14 cannot support a moment). This type of joint may include, for example, a ball joint, a fork joint or a pin joint.

A tension/compression rod 16 supports the post 12 laterally. A distal end B of the rod 16 is attached to the ground 13, while a proximal end C is attached to the post 12. Distal end B and proximal end C have revolute joints 18 and 20, respectively, which cannot transfer moments perpendicular to the plane of the support mechanism 10 (that is, in the z-direction). The joints 18 and 20 may be pin joints, fork joints or ball joints. However, if joint 18 is a ball joint, it will be necessary to support mechanism 10 in the z-direction and prevent rotation about the x-axis, such that the kinematics of mechanism 10 are constrained.

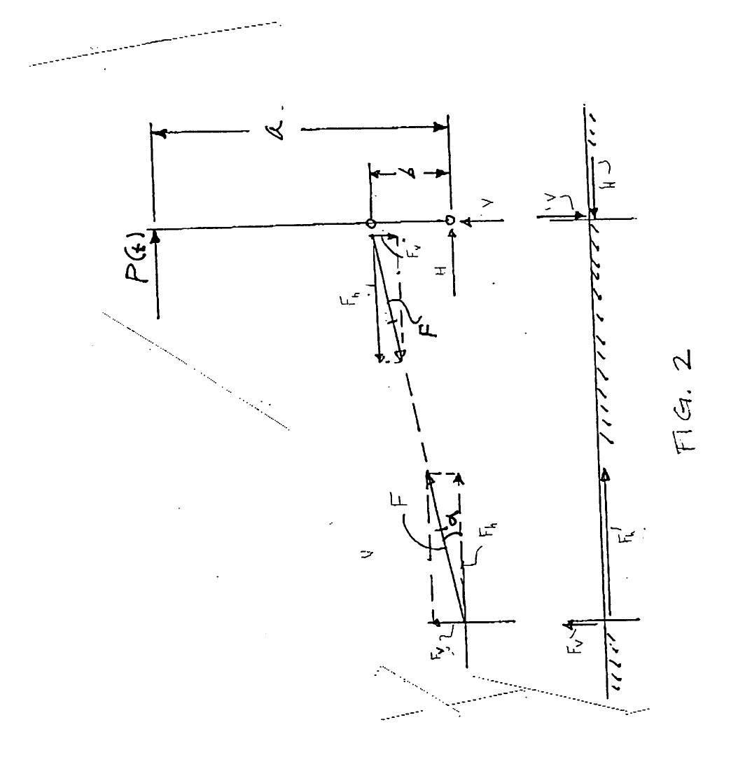

As shown in FIG. 2, a dynamic force P(t) applied at the upper end D of the post 12 results in horizontal and vertical reaction forces H, V, Fₕ, and Fᵥ in the ground 13 at the lower end A and the distal end B. One skilled in the art will recognize that the vertical reaction forces V and Fᵥ in the ground 13 are directed in opposite directions and of equal magnitude and that the horizontal reaction forces H and Fₕ in the ground 13 are opposite in sense. One skilled in the art will further recognize how to solve the free-body diagram (using the principle that the sum of all forces and moments is zero) to derive:

$$\begin{matrix}{F}_{h} = \frac{a}{b} P ; & ( 1 ) \\ {F}_{v} = V = \frac{a}{b} P tan α ; and & ( 2 ) \\ H = ( \frac{a}{b} - 1 ) P , & ( 3 )\end{matrix}$$

where dimensions a, b, and α are as shown in FIG. 2, and P is the force to be controlled (e.g., an inertial force of a mounted mechanical system). It is reiterated that Fᵥ and V are equal in magnitude but opposite in direction.

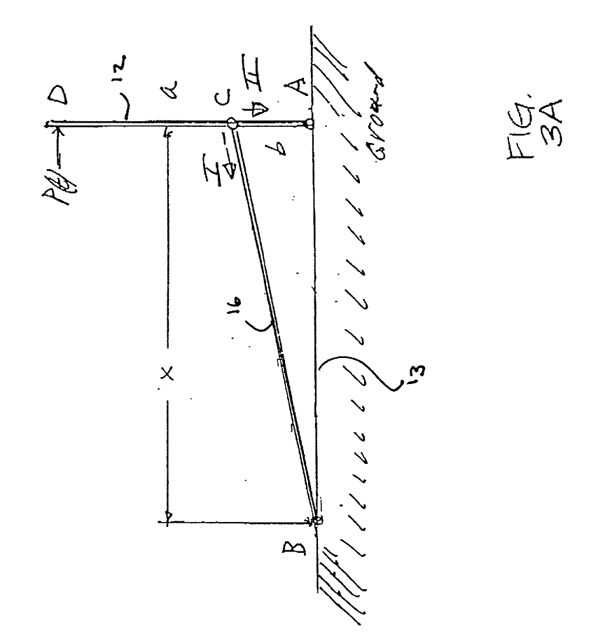

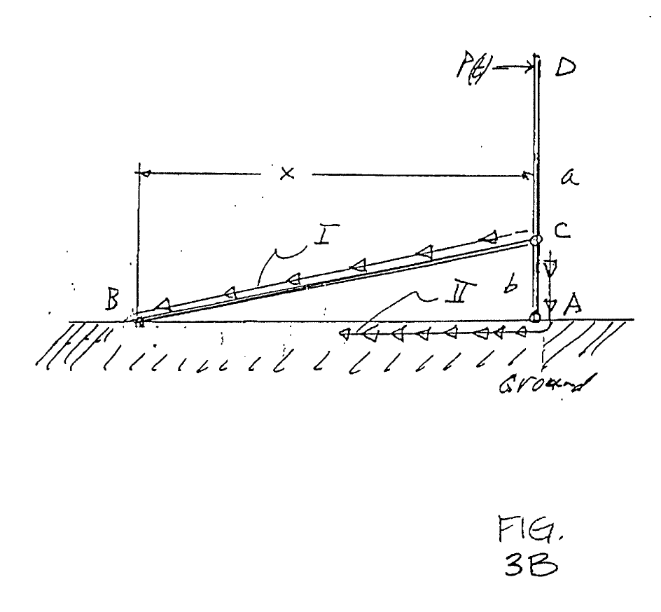

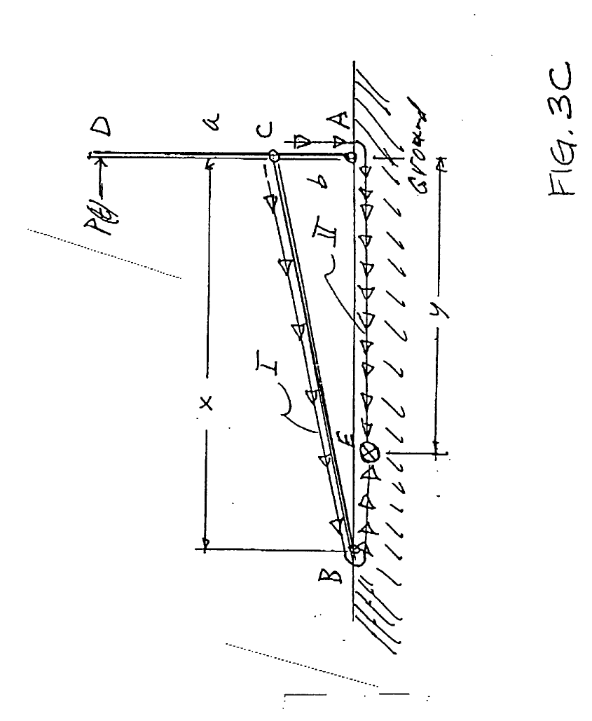

Referring now to FIGS. 3A-3C, when a dynamic force P(t) disturbance wavefront reaches proximal end C (that is, joint 20) it “splits” into two paths: one following path I through the rod 16 and into the ground 13 at distal end B, and one following path II through the short segment of the post 12 and into the ground 13 at lower end A. It will be apparent to one skilled in the art that the disturbance wavefront through the mechanism 10 is a compression/tension wave, while that through the ground 13 is a shear wave.

The disturbance wavefronts travelling along paths I and II interfere with each other in the ground 13. This interference will be constructive at some points and destructive at others. It can be shown that there exists a cancellation point E somewhere between the points A and B at which interference is destructive and the two wavefronts tend to cancel each other out, thereby minimizing the amplitude of the shear wave at that point. To determine the location of cancellation point E, the construction materials of the mechanism 10 and of the ground 13 can be assumed. Further, the travel time for both wavefronts to cancellation point E will be equal.

For example, assume that the construction material of the mechanism 10 is steel, with a compression wave speed of vₛ, and the construction material of the ground 13 is concrete, with a shear wave speed of v_{c}. One skilled in the art will understand how to derive that

$$\frac{y}{x} = \frac{y t a n α}{b} = \frac{1}{2} [ \frac{\sqrt{( 1 + {tan}^{2} α )} - tan α}{{v}_{s} / {v}_{c}} + 1 ] , \qquad ( 4 )$$

where the values of vₛ and v_{c} are obtained from appropriate tables to be 5900 m/s and 2950 m/s, respectively. Thus, the cancellation point E is determined to be situated in the range of 67% to 72% of the distance “x,” measured from lower end A, for α between 10° and 15°. This is shown as distance “y” in FIG. 3C. It will be apparent to one skilled in the art how to extend Equation 4 to other materials or configurations of mechanism 10.

Cancellation point E is a beneficial location at which to place the support of a machine that is sensitive to vertical displacement disturbances, since vertical displacement amplitudes are optimally attenuated at support point E. That is, since the interference between the wavefronts is destructive at cancellation point E, thus minimizing the amplitude of the shear wave, a machine support placed at cancellation point E will tend to experience minimal vertical disturbance. Examples of vertical displacement amplitudes that may be attenuated include, for example, ground (earth) movement.

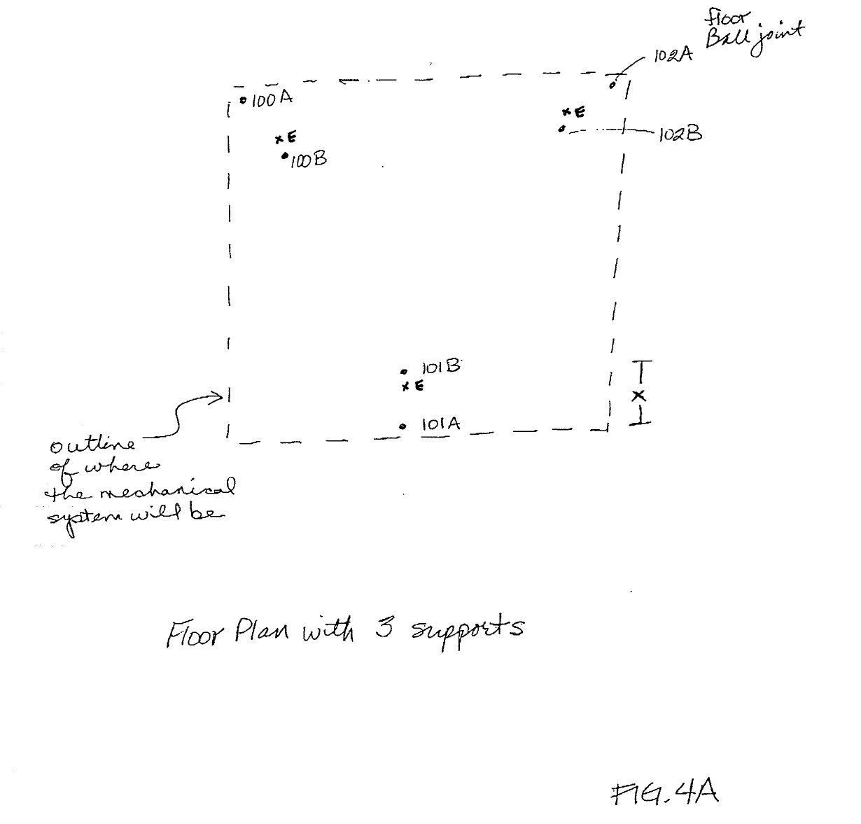

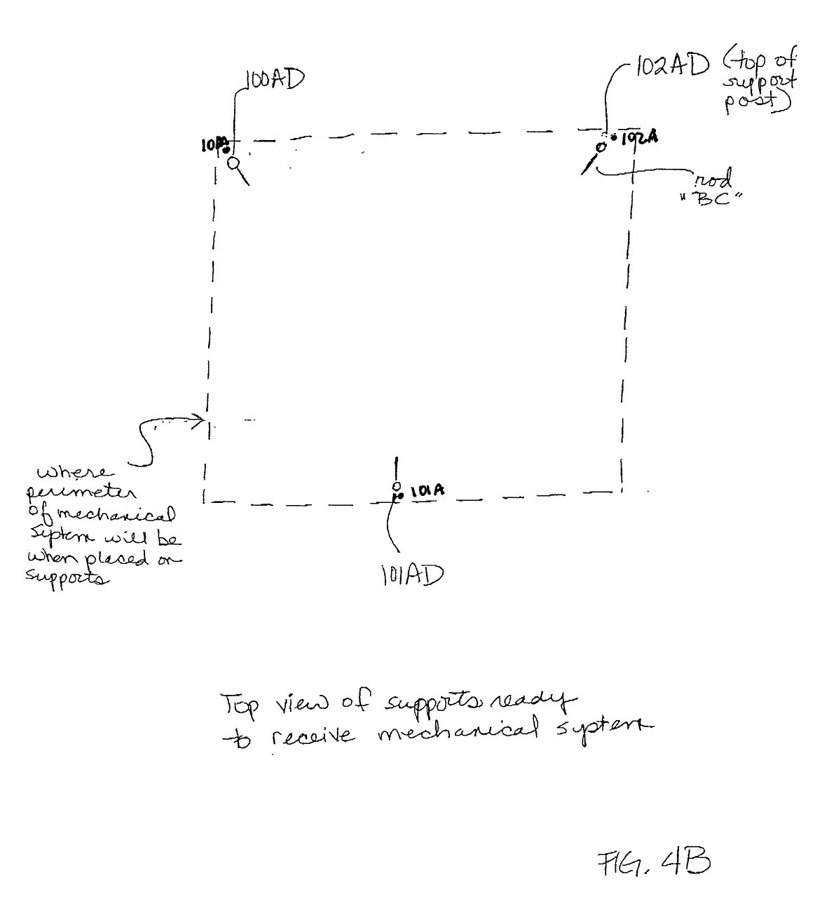

Referring now to FIGS. 4A and 4B, preferably three support devices 10 are provided to support a mechanical system, for example a several-ton photolithographic apparatus (not shown in FIGS. 4A and 4B). The mechanical system is mounted atop support devices 10 and secured thereto at their respective upper ends D by any known mechanism. As shown in FIG. 4A, the support devices 10 have lower ends A located at points 100A, 101A, and 102A and distal ends B located at points 100B, 101B, and 102B. This alignment can also be seen in FIG. 4B, where post 12 is substantially vertically aligned at points 100AD, 101AD, and 102AD. One skilled in the art will recognize that three support devices 10 are preferable, since a structure with more than three legs is not inherently stable.

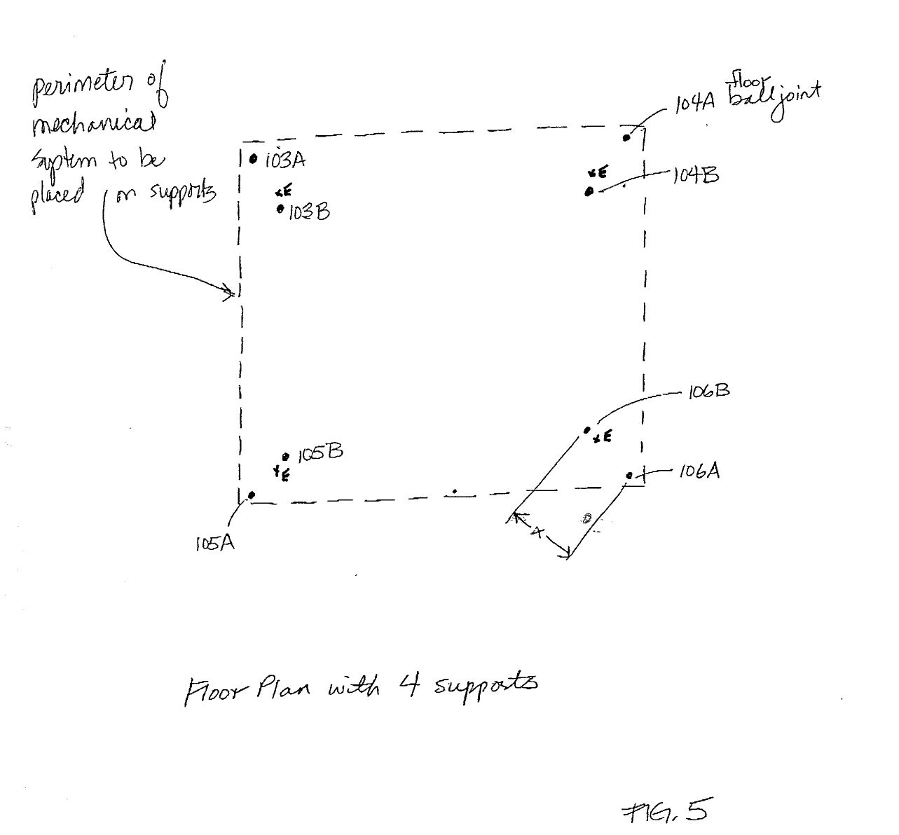

However, the use of additional, properly leveled and located support devices 10, for example as shown in FIG. 5, is also contemplated. In FIG. 5, four support devices 10 are provided to support a mechanical system, each having lower ends A located at points 103A, 104A, 105A and 106A and distal ends B located at points 103B, 104B, 105B and 106B. Cancellation points E can then be located as described above for each support device 10, and the supports for a machine sensitive to vertical disturbances may be placed at the thus-determined cancellation points E. The cancellation point E is located between the points A and B at which interference is destructive and the two wavefronts tend to cancel each other out, thereby minimizing the amplitude of the shear wave at that point.

Dynamic force P, which is an inertial force, may be any introduced force, such as the force introduced by the mounted mechanical system moving left to right. By way of example only, this movement of the mounted mechanical system may occur because of left-to-right ground movement, because the mechanical system is jarred by physical contact, or as a conservation of momentum response force to a movement within the mechanical system (e.g., movement of a countermass). Thus, the systems and apparatuses of the present invention take account of ground tremors by responding to a dynamic force P that arises from a ground motion, tending to isolate the mechanical system in which or with which the inventive floor support devices 10 are used.

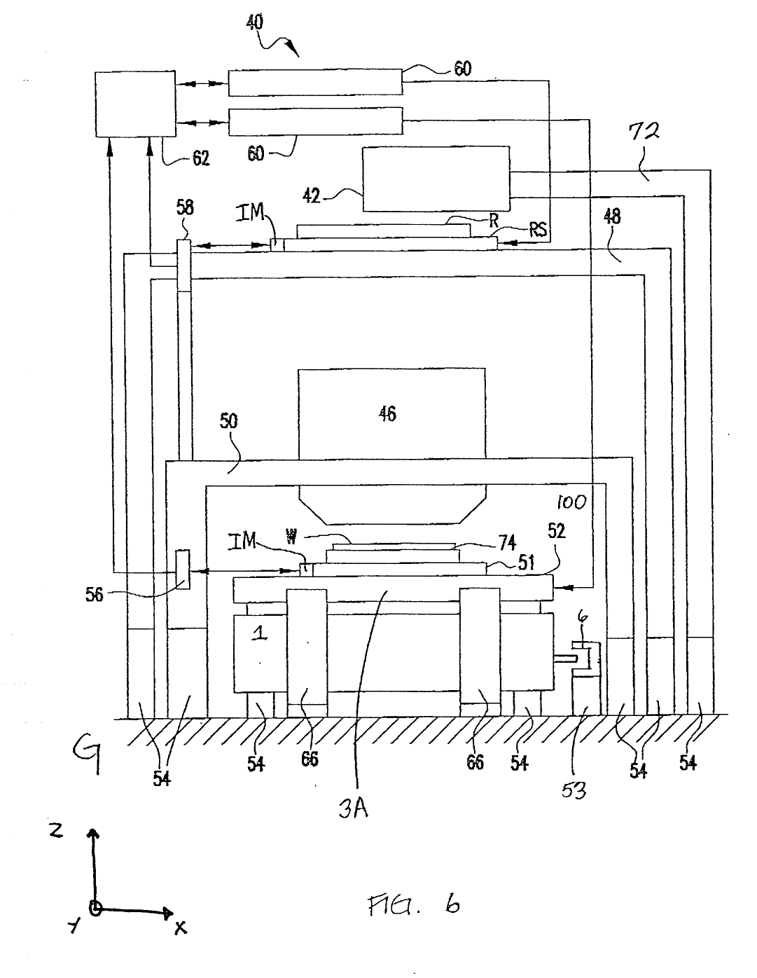

FIG. 6 is a schematic view illustrating a photolithography apparatus (exposure apparatus) 40 according to the present invention. The wafer positioning stage 52 includes a wafer stage 51, a base 1, a following stage base 3A, and an additional actuator 6. The wafer stage 51 comprises a wafer chuck 74 that holds a wafer W and an interferometer mirror IM. The base 1 is supported by a plurality of isolators 54. The isolator 54 may include a gimbal air bearing (not shown). The following stage base 3A is supported by a wafer stage frame (reaction frame) 66. The additional actuator 6 is supported on the ground G through a reaction frame 53. The wafer positioning stage 52 is structured so that it can move the wafer stage 51 in multiple (e.g., three to six) degrees of freedom under precision control by a drive control unit 60 and system controller 62, and position the wafer W at a desired position and orientation relative to the projection optics 46. In this embodiment, the wafer stage 51 has six degrees of freedom by utilizing the Z direction forces generated by the x motor and the y motor of the wafer positioning stage 52 to control a leveling of the wafer W. However, a wafer table having three degrees of freedom (z, θₓ, θ_{y}) or six degrees of freedom can be attached to the wafer stage 51 to control the leveling of the wafer. The wafer table includes the wafer chuck 74, at least three voice coil motors (not shown), and bearing system. The wafer table is levitated in the vertical plane by the voice coil motors and supported on the wafer stage 51 by the bearing system so that the wafer table can move relative to the wafer stage 51.

The reaction force generated by the wafer stage 51 motion in the X direction can be canceled by the motion of the base 1 and the additional actuator 6. Further, the reaction force generated by the wafer stage 51 motion in the Y direction can be canceled by the motion of the following stage base 3A.

An illumination system 42 is supported by a frame 72. The illumination system 42 projects radiant energy (e.g., light) through a mask pattern on a reticle R that is supported by and scanned using a reticle stage RS. The reaction force generated by motion of the reticle stage RS can be mechanically released to the ground through a reticle stage frame 48 and the isolator 54, in accordance with the structures described in JP Hei 8-330224 and U.S. Pat. No. 5,874,820, the entire contents of which are incorporated by reference herein. The light is focused through a projection optical system (lens assembly) 46 supported on a projection optics frame 50 and released to the ground through isolator 54.

An interferometer 56 is supported on the projection optics frame 50 and detects the position of the wafer stage 51 and outputs the information of the position of the wafer stage 51 to the system controller 62. A second interferometer 58 is supported on the projection optics frame 50 and detects the position of the reticle stage RS and outputs the information of the position to the system controller 62. The system controller 62 controls a drive control unit 60 to position the reticle R at a desired position and orientation relative to the wafer W or the projection optics 46.

In the embodiments of the present invention, the projections optics frame 50 is mounted to the ground at the cancellation point E by utilizing either three or four supporting devices 10. More particularly, the interferometer 56 and second interferometer 58 are both mounted to ground by the optics frame 50 (in addition to the projection optics 46) at the cancellation point E; that is, the interferometer 56 and second interferometer 58 (and projection optics 46) are mounted to ground by the optics frame 50 on supports located at points whereat the interference between at least two divided wavefronts is destructive. In addition, at least the reaction frame 53 and the wafer stage frame 66 correspond to the post 12 that is connected to the ground G at point A of FIG. 1. More specifically, the reaction frame 53, the wafer stage frame 66 as well as the wafer positioning stage 52 and the wafer stage 51 comprising the wafer chuck 74 that holds a wafer W and an interferometer mirror IM correspond to the post 12 that is connected to the ground G at point A of FIG. 1.

Further, any support members that can transmit the reaction forces or vibrations to the ground G, may be connected to the ground G at a point A of FIG. 1. For example, the frame 72 supporting the illumination system 42 and the reticle stage frame 48 can be connected to the ground G at point A of FIG. 1. If there are many members that should be connected to the ground G at point A, these members may be supported by a main support member that is connected to the ground G at point A instead of connecting each member to the ground G at point A. Oppositely, any support members that should be isolated from the reaction forces or vibrations, may be connected to the ground G at the cancellation point E for FIG. 3C. For example, the base 1 can be connected to the ground G at the cancellation point E with or without isolator 54. If there are many isolated members should be connected to the ground G. at the cancellation point E, these isolated members may be supported by a main isolated support member that is connected to the ground G at the cancellation point E, instead of connecting each isolated member to the ground G at the cancellation point E.

There are a number of different types of photolithographic devices. For example, apparatus 40 may comprise an exposure apparatus that can be used as a scanning type photolithography system which exposes the pattern from reticle R onto wafer W with reticle R and wafer W moving synchronously. In a scanning type lithographic device, reticle R is moved perpendicular to an optical axis of projection optics 46 by reticle stage RS and wafer W is moved perpendicular to an optical axis of projection optics 46 by wafer positioning stage 52. Scanning of reticle R and wafer W occurs while reticle R and W are moving synchronously in the x direction.

Alternatively, exposure apparatus 40 can be a step-and-repeat type photolithography system that exposes reticle R while reticle R and wafer W are stationary. In the step and repeat process, wafer W is in a fixed position relative to reticle R and projection optics 46 during the exposure of an individual field. Subsequently, between consecutive exposure steps, wafer W is consecutively moved by wafer positioning stage 52 perpendicular to the optical axis of projection optics 46 so that the next field of semiconductor wafer W is brought into position relative to projection optics 46 and reticle R for exposure. Following this process, the images on reticle R are sequentially exposed onto the fields of wafer W so that the next field of semiconductor wafer W is brought into position relative to projection optics 46 and reticle R.

However, the use of apparatus 40 provided herein is not limited to a photolithography system for semiconductor manufacturing. Apparatus 40 (e.g., an exposure apparatus), for example can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

In the illumination system 42, the illumination source can be g-line (436 nm), i-line (365 nm), KrF excimer laser (248 mm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆) or tantalum (Ta) can be used as ion sources in an electron gun. Furthermore, in the case where an electron beam is used, the structure could be such that either a mask is used or a pattern can be directly formed on a substrate without the use of a mask.

With respect to projection optics 46, when far ultra-violet rays such as the excimer laser is used, glass materials such as quartz and fluorite that transmit far ultra-violet rays are preferably used. When the F₂ type laser or x-ray is used, projection optics 46 should preferably be either catadioptric or refractive (a reticle should also preferably be a reflective type), and when an electron beam is used, electron optics should preferably comprise electron lenses and deflectors. The optical path for the electron beams should be traced in vacuum.

Also, with an exposure device that employs vacuum ultra-violet radiation (VUV) of wavelength 200 nm or less, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japanese Patent Application Disclosure No.10-20195 and its counterpart U.S. Pat. No. 5,835,275. In these cases, the reflecting optical device can be a catadioptric optical system incorporating a beam splitter and concave mirror.

Japanese Patent Application Disclosure No. 8-334695 published in the Official Gazette for Laid-Open Patent Applications and its counterpart U.S. Pat. No. 5,689,377 as well as Japanese Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above-mentioned U.S. patents, as well as the Japanese patent applications published in the Office Gazette for Laid-Open Patent Applications are incorporated herein by reference.

Further, in photolithography systems, when linear motors that differ from the motors shown in the above embodiments (see U.S. Pat. No. 5,623,853 or 5,528,118) are used in one of a wafer stage or a reticle stage, the linear motors can be either an air levitation type employing air bearings or a magnetic levitation type using Lorentz force or reactance force. Additionally, the stage could move along a guide, or it could be a guideless type stage that uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference. As described above, a photolithography system according to the above described embodiments can be built by assembling various subsystems in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

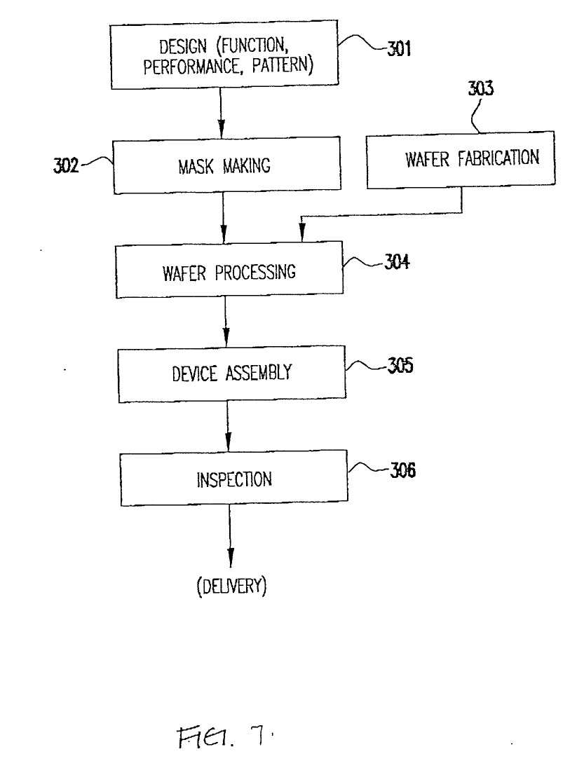

Further, semiconductor devices can be fabricated using the above described systems, by the process shown generally in FIG. 7. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305 the semiconductor device is assembled (including the dicing process, bonding process and packaging process), then finally the device is inspected in step 306.

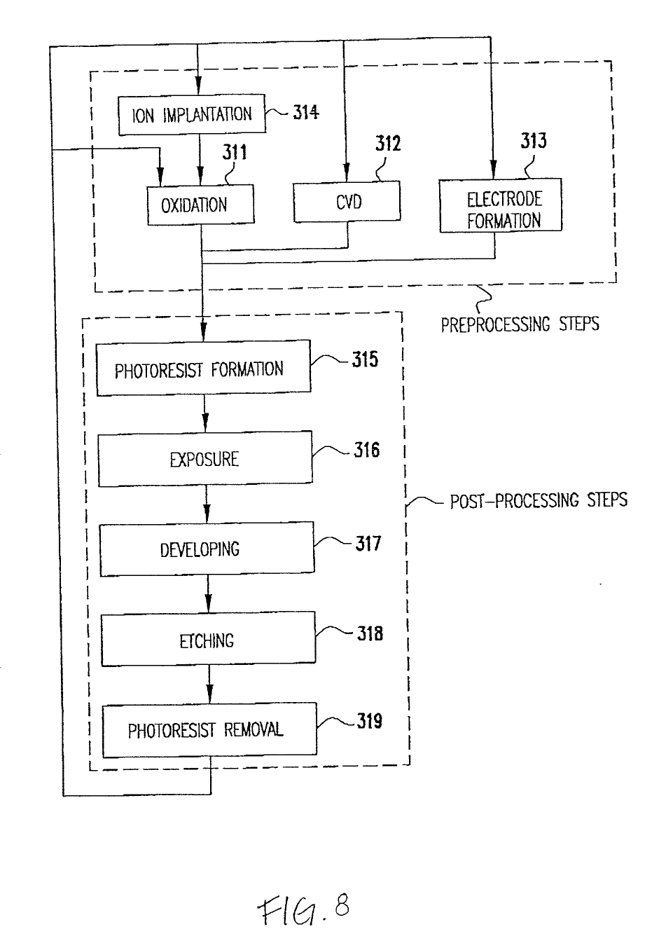

FIG. 8 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially in step 315 (photoresist formation step), photoresist is applied to a wafer. Next, in step 316 (exposure step), the above-mentioned exposure apparatus is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these pre-processing and post-processing steps.

Although the invention has been particularly discussed in a photolithography system as an exemplary example, the inventive products, methods and systems may be used in other and further contexts, including any applications where it is desired to reduce or minimize vibrations, such as precision apparatuses (e.g., photography systems).

It will be apparent to those skilled in the art that various modifications and variations can be made in the methods described, in the stage device, the control system, the material chosen for the present invention, and in construction of the photolithography systems as well as other aspects of the invention without departing from the scope or spirit of the invention. While the invention has been described in terms of preferred embodiments, those skilled in the art will recognize that the invention can be practiced with modification within the spirit and scope of the appended claims.

What is claimed is:

1. A method of minimizing an undesirable disturbance experienced in a mechanical system sensitive to vertical displacements, comprising the steps of:
dividing the undesirable disturbance into at least a first divided wavefront and a second divided wavefront, the at least first and second divided wavefronts entering a ground at different points and interfering with each other therein to form a composite wavefront;
locating a cancellation point within the ground whereat the at least first and second divided wavefronts destructively interfere with each other and minimize an amplitude of the composite wavefront; and
positioning a support of the mechanical system at the cancellation point.

2. The method according to claim 1, further comprising the step of providing an initial pathway for the undesirable disturbance along a first member, and wherein said step of dividing the undesirable disturbance further comprises dividing the undesirable disturbance at a joint connecting the first member and a second member.

3. The method according to claim 2, wherein said joint is one of a ball joint, a fork joint and a pin joint.

4. The method according to claim 2, wherein the first member comprises a substantially vertical rod and the second member comprises a tension-compression rod.

5. The method according to claim 2, wherein the first member is attached to the ground at a ball joint and the second member is attached to the ground at one of a ball joint, fork joint and a pin joint.

6. The method according to claim 2, wherein the first divided wavefront travels along the second member into the ground and said second divided wavefront travels along the first member into the ground.

7. The method according to claim 1, wherein said step of dividing the undesirable disturbance comprises dividing the undesirable disturbance into two divided wavefronts.

8. A support system for supporting a mechanical system, comprising:
at least three support devices, said support devices comprising:
a first member having an upper end and a lower end, said lower end being secured to a ground at a ball joint;
a second member having a distal end and a proximal end, said proximal end being secured to said first member at a first revolute joint, said distal end being secured to the ground at a second revolute joint remote from said ball joint.

9. The support system according to claim 8, wherein said support system comprises exactly three floor supports.

10. The support system according to claim 8, wherein said first and second revolute joints are one of a fork joint and a pin joint.

11. The support system according to claim 8, wherein said first member is substantially vertical.

12. The support system according to claim 8, wherein said upper end of said first member is adapted for attachment to the mechanical system.

13. The support system according to claim 8, wherein the mechanical system is several tons in mass.

14. The support system according to claim 8, wherein the mechanical system is a mechanical system for precision movement.

15. The support system according to claim 14, wherein the mechanical system is a photolithographic apparatus.

16. The support system according to claim 8, wherein said support system provides interference between at least two divided wavefronts of an disturbance experienced by said mechanical system.

17. The support system according to claim 16, further comprising a second mechanical system sensitive to vertical displacements, said second mechanical system having supports located at points whereat the interference between said at least two divided wavefronts is destructive.

18. The support system according to claim 17, wherein at least one of said mechanical system and said second mechanical system includes:
a wafer positioning stage having at least a wafer stage with a wafer chuck and a following stage base;
an interferometer mirror IM mounted on the wafer stage;
a plurality of isolators supporting the wafer positioning stage;
a wafer stage frame supporting the following stage base;
a projection optics frame supporting a first and second interferometer and projection optics which illuminates a wafer in the wafer chuck; and
a reaction frame positioned proximate to the plurality of isolators.

19. The support system according to claim 18, wherein said wafer positioning stage is structured so that it can move the wafer stage in multiple degrees of freedom.

20. The support system according to claim 18, wherein at least said reaction frame and said wafer stage frame are supported by said first member that is connected to the ground.

21. The support system according to claim 18, wherein the positioning stage and the wafer stage comprising the wafer chuck that holds the wafer W and the interferometer mirror IM are further supported by the first member that is connected to the ground.

22. The support system according to claim 18, wherein said projections optics frame is mounted on the supports located at points whereat the interference between said at least two divided wavefronts is destructive.

23. The support system according to claim 22, wherein the first interferometer, second interferometer and the projection optics are mounted on the supports located at points whereat the interference between said at least two divided wavefronts is destructive.

24. An exposure apparatus, comprising:
a precision movement system sensitive to vertical displacements mounted on a ground; and
a mechanical system mounted to at least three support devices, each of said support devices comprising:
a first member having an upper end and a lower end, said lower end being secured to the ground by a first joint incapable of sustaining a moment; and
a second member having a distal end and a proximal end, said proximal end being secured to said first member at a junction point, said distal end of said second member being secured to the ground at a second joint remote from said first joint,
wherein said mechanical system is mounted to said at least three support devices at respective upper ends of said at least three support devices.

25. The exposure apparatus according to claim 24, wherein said junction point is a revolute joint capable of sustaining a moment in one direction.

26. The exposure apparatus according to claim 24, wherein a disturbance experienced by said mechanical system is divided into a first divided wavefront and a second divided wavefront at each support device, said first and second divided wavefronts being transferred into the ground through said support devices.

27. The exposure apparatus according to claim 26, wherein said first and second divided wavefronts interfere with each other in the ground to form at least one composite wavefront.

28. The exposure apparatus according to claim 26, wherein the precision movement system is mounted to the ground at points whereat an amplitude of said at least one composite wavefront is a minimum.

29. A device manufactured with the exposure apparatus of claim 24.

30. A wafer on which an image has been formed by the exposure apparatus of claim 24.
